(19) United States
(12) Patent Application Publication
(10) Pub. No.: US 2009/0170504 A1
(43) Pub. Date: Jul. 2, 2009

(54) COMMUNICATION TERMINAL, COMMUNICATION METHOD, AND COMMUNICATION PROGRAM

(75) Inventors: Hidehiko SATOH, Fukuoka (JP); Atsushi Tsukazoe, Fukuoka (JP); Yoshiaki Kawakatsu, Fukuoka (JP); Toshihiro Iyama, Fukuoka (JP); Naohiro Nakamura, Fukuoka (JP); Tatsuya Tanoue, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/343,498

(22) Filed: Dec. 24, 2008

(30) Foreign Application Priority Data
Dec. 26, 2007 (JP) 2007-334463

(51) Int. Cl. H04W 4/00; H04B 1/38

(52) U.S. Cl. 455/426.1; 455/90.2

(57) ABSTRACT

According to an aspect of an embodiment, a communication terminal connectable to a communication network system transmits user data obtained by one communication terminal gaining a voice to other communication terminals through a network. The communication terminal includes a transmitter, a receiver, a voice request part which receives a voice gain request from a user, a voice gain recognition part which recognizes that the voice is gained, a data obtaining part which obtains user data, a data storage which stores data, and a data management part which causes the data storage to store the user data after receiving a voice gain request and which receives the recognition of the voice gain. The transmitter transmits the user data part after receiving the voice gain request from the user.

### CROSS-REFERENCE TO RELATED APPLICATIONS

This application is related to and claims priority under 35 U.S.C §119(a) on Japanese Patent Publication No. 2007-334463 filed on Dec. 26, 2007 in the Japan Patent Office, and incorporated by reference herein.

### BACKGROUND

1. Field

The present invention relates to a communication terminal, a communication method, and a communication program.

2. Description of the Related Art

The PoC/W (Push to talk over Cellular/Wireless) is known as a communication method which utilizes, for example, a plurality of portable phone terminals as a communication terminal like a transceiver (for example, refer to National Publication of International Patent Application No. 2007-503182). In the PoC/W (hereinafter, also referred to as PoC), it is possible to execute a phone call one by one, and also to execute a phone call for concurrently transmitting same information to a plurality of the portable phone terminals in a group (hereinafter, referred to as concurrent same information phone call) on a network by forming a group of three or more members who want to conduct a phone call with the portable phone terminal. In the phone call with the PoC/W, only a user who requests a voice to gain the voice can speak within a certain time after gaining the voice. Herein, the “voice” means the right for a user to speak. That is, in the phone call with the PoC/W, it is necessary to gain the voice because of the characteristic of the concurrent same information phone call. If the voice cannot be gained, a phone call participant cannot transmit user data (voice sound, a still image, a moving image, and the like) to another phone call participant.

### SUMMARY

According to an aspect of an embodiment, in a communication group, which is made up of a plurality of communication terminals connectable to a communication network system, a communication network system transmits user data obtained by one communication terminal, which gains a voice, to other communication terminals through a network. The communication network system includes a transmitter which transmits data to the network; a receiver which receives data transmitted via the network; a voice request part which receives a voice gain request from a user to instruct the transmitter to transmit the voice request data; a voice gain recognition part which recognizes that the voice is gained when the receiver receives speech permit data; a data obtaining part which obtains the user data; a data storage which stores data; and a data management part, which causes the data storage to store the user data obtained by the data obtaining part after receiving a voice gain request by the voice request part from the user, receives recognition that the voice is gained by the voice gain recognition part, and causes the transmitter to transmit the user data obtained by the data obtaining part after receiving the voice gain request transmitted by the voice request part from the user.

### BRIEF DESCRIPTION OF THE DRAWINGS

FIG. 1 is a diagram illustrating a communication network system including a portable terminal according to an embodiment of a communication terminal of the present invention;

FIG. 2 is a diagram illustrating an example of a configuration of a portable terminal illustrated in FIG. 1;

FIG. 3 is a block diagram illustrating an example of a configuration of a control part illustrated in FIG. 2;

FIG. 4 is a diagram illustrating an example of both a configuration of voice sound data stored in a data storage and a configuration of the voice sound data to be transmitted;

FIG. 5 is a diagram illustrating an example of a structure of a database stored in the data storage;

FIG. 6 is an operation flow illustrating a data transmission operation in a button mode of the portable terminal illustrated in FIG. 1;

FIG. 7 is an operation flow illustrating a voice discard operation following FIG. 6;

FIG. 8 is an operation flow illustrating a data transmission operation in a voice sound mode of the portable terminal illustrated in FIG. 1;

FIG. 9 is an operation flow illustrating a voice discard operation following FIG. 8;

FIG. 10 is an operation flow illustrating an operation of the portable terminal illustrated in FIG. 1 when speech permit data is not received in a data discard mode; and

FIG. 11 is an operation flow illustrating an operation when the portable terminal illustrated in FIG. 1 is temporarily moved outside the communication.

### DETAILED DESCRIPTION OF THE EMBODIMENTS

The embodiments of the present invention will be described below by referring to the drawings.

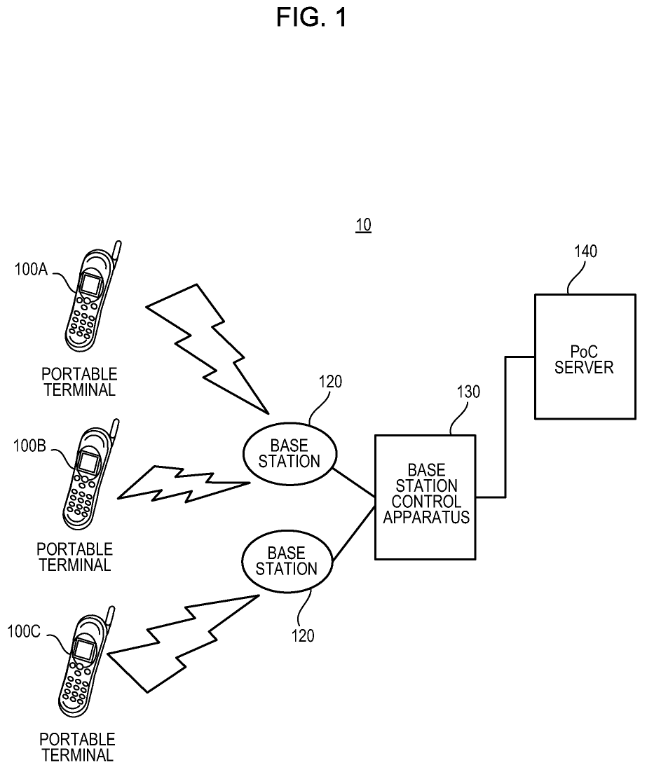

FIG. 1 is a diagram illustrating a communication network system including a portable terminal according to an embodiment of a communication terminal of the present invention.

A communication network system 10 illustrated in FIG. 1 includes a plurality of base stations 120, a plurality of portable terminals 100 (100A, 100B, and 100C), a base station control apparatus 130, and a PoC server 140.

A plurality of base stations 120 operates as relay stations when the portable terminals 100 in a communication area of the base station 120 mutually communicate. The plurality of base stations 120 also communicates with the portable terminals 100 in the communication area as remote stations. The base station control apparatus 130 manages a plurality of such base stations 120. The base station control apparatus 130 relays the communication between the portable terminals 100 connected to the different base stations 120. The PoC server 140 is connected to the base station control apparatus 130 through an IP network. The PoC server 140 manages a group made up of PoC users and their portable terminals 100. The PoC server 140 executes a PoC control function and a PoC participation function to realize a network function for PoC service. The PoC server 140 executes exclusion control for voices among the portable terminals 100A, 100B, and 100C. The PoC server 140 permits only one of the portable terminals 100A, 100B, and 100C to speak. The PoC server 140 executing the PoC control function establishes a number of SIP (Session Initiation Protocol) sessions that is the same as the number of the portable terminals 100 of users participating in the PoC. However, the speech from the portable terminal 100 of the PoC user is controlled by using one PoC session. The PoC control function and the PoC participation function of the PoC server 140 communicate with each other. In addition, the PoC participation function of the PoC server 140 communicates with the portable terminals 100.

In the communication network system 10 of the present embodiment, the PoC server 140 obtains the user data transmitted from one portable terminal 100A gaining the voice to concurrently transmit the obtained user data to the other portable terminals 100B and 110C through the network in a communication group made up of a plurality of other portable terminals 100.

Next, an example of a configuration of the portable terminals 100 will be described.

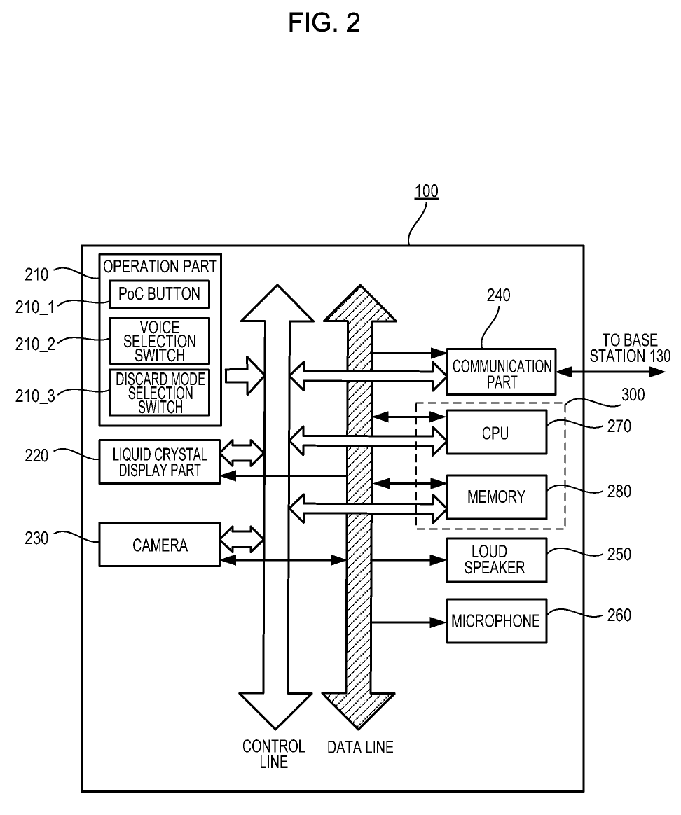

FIG. 2 is a diagram illustrating an example of a configuration of the portable terminal 100 illustrated in FIG. 1.

The portable terminal 100 illustrated in FIG. 1 is provided with a communication part 240, an operation part 210, a microphone 260, a loud speaker 250, a camera 230, a liquid crystal display part 220, a CPU 270 controlling each part of the portable terminal 100, and a memory 280 storing data. The communication part 240, the operation part 210, the microphone 260, the loud speaker 250, the camera 230, the liquid crystal display part 220, the memory 280, and the CPU 270 are connectable to each other by a control line and a data line.

The communication part 240 includes a transmission function which transmits data to the network, and a receiving function which receives data via the network.

The operation part 210 includes a PoC button 210_1, a voice selection switch 210_2, and a discard mode selection switch 210_3. The voice selection switch 210_2 receives a voice request selection operation of the user. The PoC button 210_1 is operated to switch the mode setting for a button mode which requests the voice, or a voice sound mode which requests the voice by inputting a voice sound into the microphone 260. When the button mode is selected, and the user wants to gain the voice, the user presses the voice selection switch 210_2. The discard mode selection switch 210_3 receives a discard mode selection operation by the user. The discard mode selection switch 210_3 selects any one of either data-discard or data-hold as a discard mode. The voice selection switch 210_2 corresponds to an example of a voice request selection part of the present embodiment of the present invention. The discard mode selection switch 210_3 corresponds to an example of a discard mode selection operation part of the present embodiment of the present invention. The operation part 210 may be provided with a switch, which receives a forced discard operation as a user data-discard request, and a variety of switches for setting and registering in addition to the PoC button 210_1, the voice selection switch 210_2, and the discard mode selection switch 210_3.

The microphone 260 obtains a voice sound as the user data. The loud speaker 250 outputs the voice sound. The camera 230 obtains an image. The liquid crystal display part 220 displays and outputs the image. A control part 300 is provided with the CPU 270 and the memory 280. The CPU 270 executes a program stored in the memory 280 to control each part other than the CPU 270.

For example, in a PoC communication group made up of the three portable terminals 100A, 100B, and 100C illustrated in FIG. 1, when the portable terminal 100A gains the voice, the voice sound data is collected by the microphone 260 of the portable terminal 100A, and is concurrently transmitted from the communication part 240 of the portable terminal 100A to other portable terminals 100B and 100C through the network. When another portable terminal belonging to the PoC communication group gains the voice, the portable terminal 100A outputs a user data of the other portable terminal from the loud speaker 250 of the portable terminal 100A. The user data is the voice sound data received by the communication part 240 of the portable terminal 100A from the communication part 240 of the other portable terminal gaining the voice through the network. Meanwhile, the present embodiment of the present invention will be described by using an example of the voice sound as the user data transmitted by the portable terminal 100. As the user data of the present embodiment of the present invention, for example, an image photographed by the camera 230 or a combination of the image and a voice sound may be adopted, and the image may be also displayed on the liquid crystal display part 220.

The communication part 240 executing the transmission function corresponds to an example of a transmitter of the present embodiment of the present invention. The communication part 240 executing the receiving function corresponds to an example of a receiver of the present embodiment of the present invention. The voice selection switch 210_2 corresponds to an example of the voice request selection part of the present embodiment of the present invention.

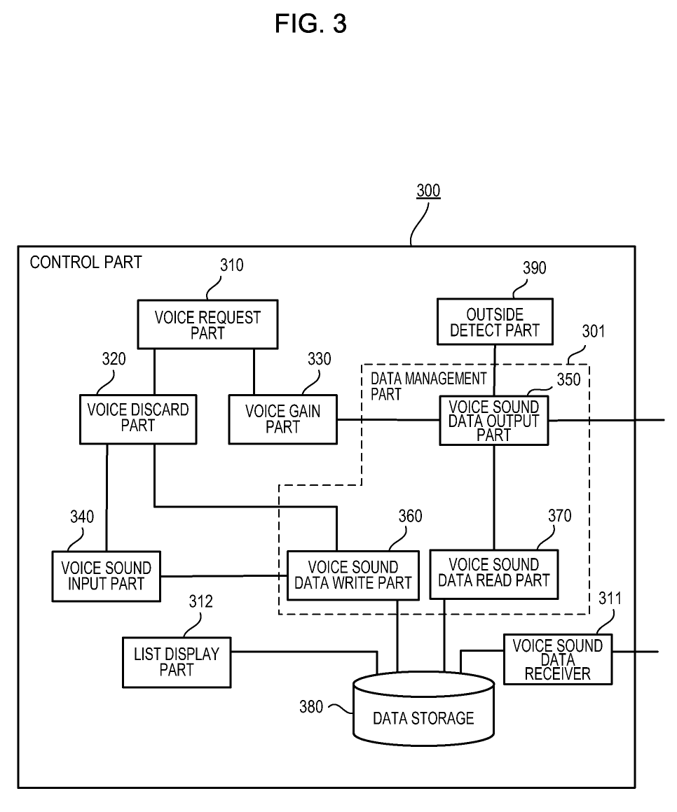

FIG. 3 is a block diagram illustrating an example of a configuration of the control part 300 of the portable terminal 100 illustrated in FIG. 2.

Each part of the control part 300 of the portable terminal, which is illustrated in FIG. 3, is realized through the execution of the programs stored in the memory 280 by the CPU 270 illustrated in FIG. 2. Each part of the control part 300 operates in cooperation with each part of illustrated in FIG. 2. FIG. 3 will be described below also referring to FIG. 2.

The control part 300 of the portable terminal 100 is provided with a voice request part 310, a voice discard part 320, a voice gain part 330, a voice sound input part 340, a voice sound data storage 380, an outside detect part 390, a list display part 312, a voice sound data receiver 311, and a data management part 301. The data management part 301 is provided with a voice sound data write part 360, a voice sound data read part 370, and a voice sound data output part 350.

A combination of the voice request part 310 and the voice discard part 320 corresponds to an example of a voice request part. The voice gain part 330 corresponds to an example of a voice gain recognition part. The voice sound input part 340 corresponds to an example of a data obtain part. The voice sound data storage 380 corresponds to an example of a data storage. The data management part 301 corresponds to an example of a data management part.

When receiving a voice gain request from the user, the voice request part 310 of the portable terminal 100 instructs the communication part 240 to transmit voice request data. When receiving a voice discard request from the user, the voice discard part 320 instructs the communication part 240 to transmit voice discard data. The voice request part 310 gains the voice. The voice discard part 320 discards the voice. Next, the operation will be described in more detail. The voice request part 310 receives the voice gain request from the user to instruct the communication part 240 (refer to FIG. 2) to transmit the voice request data. The voice request data transmitted from the communication part 240 is received by the PoC server 140 (refer to FIG. 1). When the portable terminals 100B and 100C other than the portable terminal 100A transmitting the voice request data are permitted to speak, after receiving the voice discard data from the portable terminal that has the voice, the PoC server 140 transmits speech permit data to the portable terminal 100A. When any one of the portable terminals 100B and 100C is not permitted to speak, the PoC server 140 promptly transmits the speech permit data to the portable terminal 100A. Meanwhile, attribute information expressing a permit order of the voice is included in the speech permit data transmitted by the PoC server 140. In addition, the attribute information also includes a PoC number identifying a series of speeches, a transmission time, and information expressing the permitted portable terminal. According to the voice request selection operation by the user, which is received by the voice selection switch 210_2, the voice request part 310 of the portable terminal 100 selects a type of an input to be received as the voice gain request by the user. That is, when the voice selection switch 210_2 is set to the button mode, the voice request part 310 receives the pressing operation of the PoC button 210_1 as the voice gain request by the user. On the other hand, when the voice selection switch 210_2 is set to the voice sound mode, the voice request part 310 receives the voice sound obtained by the voice sound input part 340 as the voice gain request by the user.

The voice gain part 330 recognizes that the voice is gained when the speech permit data is received by the communication part 240 (refer to FIG. 2).

The voice discard part 320 receives the voice discard request by the user, and causes the communication part 240 to transmit the voice discard data. Here, when receiving the voice discard request from the user, the voice discard part 320 does not cause the communication part 240 to immediately transmit the voice discard data, but, after it has completed to transmit the voice sound data stored in the voice sound data storage 380, the voice discard part 320 causes the communication part 240 to transmit the voice discard data to the PoC server 140. Meanwhile, according to the voice request selection operation of the voice selection switch 210_2 by the user, the voice discard part 320 selects a type of an input to be received as the voice discard request by the user. That is, when the user sets the voice selection switch 210_2 to the button mode, the voice discard part 320 receives the PoC button 210_1 release operation by the user as the voice discard request by the user. If the voice selection switch 210_2 is set to the voice sound mode by the user, when the voice sound input part 340 detects that the input voice sound is silent, the voice sound input part 340 receives the silent condition as the voice gain request by the user.

The voice sound input part 340 obtains the voice sound data as the user data from the microphone 260.

The voice sound data storage 380 has a memory 280, and stores the voice sound and the attribute information expressing the permit order of the voice corresponding to the voice sound data.

The outside detect part 390 checks at certain times whether or not the communication part 240 (refer to FIG. 2) can communicate with the closest base station to detect condition changes between inside the communication range which can transmit/receive data to/from the network, and outside the communication range.

The data management part 301 causes the voice sound data storage 380 to store the voice sound data of the user. The voice sound data of the user is obtained by the voice sound input part 340. The data management part 301 reads the voice sound data stored in the voice sound data storage 380, and causes the communication part 240 to transmit the read voice sound data to the PoC server 140. The voice sound data is transmitted with the attribute information obtained from the PoC server 140. The voice sound data write part 360 stores the voice sound data in the voice sound data storage 380. The voice sound data is read by the voice sound data read part 370 from the voice sound data storage 380, and the read voice sound data is transmitted by the voice sound data output part 350. The voice sound data output part 350 transmits a data read request signal to the voice sound data read part 370 to cause the voice sound data read part 370 to read the voice sound data. When reading the voice sound data from the voice sound data storage 380, the voice sound data read part 370 detects a voice sound level in the voice sound data. A silent part, in which the voice sound level in the voice sound data is lower than a given reference, is processed as an invalid part, and is not delivered to the voice sound data output part 350, and the other parts are continued to be delivered.

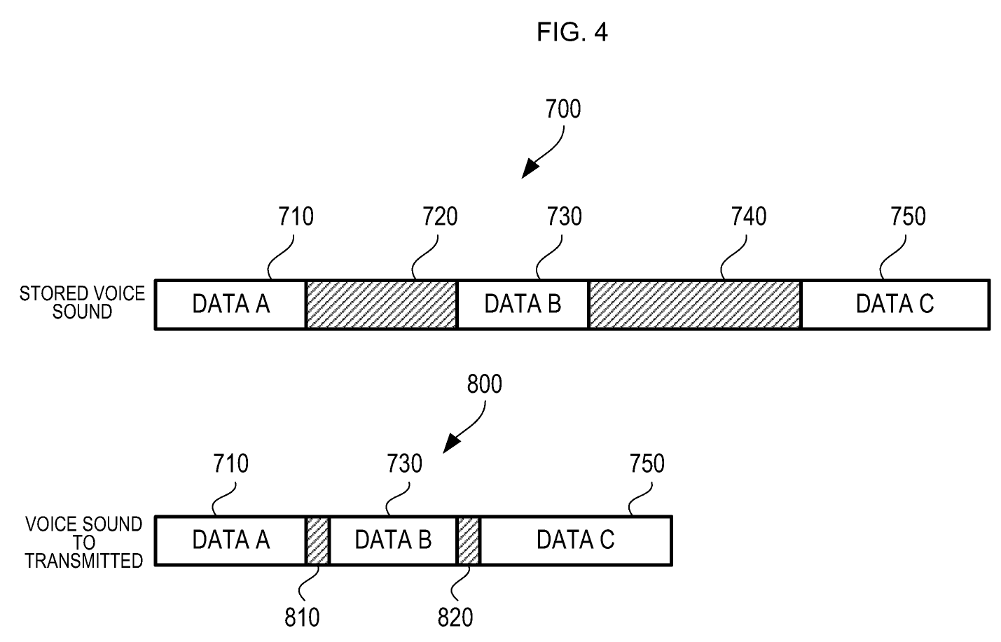

FIG. 4 is a diagram illustrating a configuration of the voice sound data stored in the voice sound data storage 380 and a configuration of the voice sound data to be transmitted.

As illustrated in FIG. 4, the stored voice sound data 700 includes silent part 720 between data A 710 and data B 730, and silent part 740 between data B 730 and data C 750. The voice sound data read part 370 does not transmit the silent parts 720 and 740 to the voice sound data output part 350, but transmits the data A 710, the data B 730, and the data C 750. Meanwhile, the voice sound data read part 370 inserts short silent parts 810 and 820 to indicate that the silent parts 720 and 740 are skipped between data A 710 and data B 730, and data B 730 and data C 750. In this way, the voice sound without silent parts is efficiently transmitted. The silent parts are processed by the voice sound data read part 370, but may be processed by the voice sound data write part 360 when storing the voice sound data. If the voice sound data write part 360 stores the voice sound data, the voice sound data is stored with the silent time shortened so that the memory capacity becomes smaller. When the outside detect part 390 detects a change from inside the communication range to outside the communication range, the voice sound data read part 370 interrupts to read and transmit the voice sound data, and when the outside detect part 390 detects the change from outside the communication range to inside the communication range, the voice sound data read part 370 restarts to read and transmit the voice sound data.

Here, the data management part 301 will be described in more detail.

The data management part 301 causes the voice sound data storage 380 to store the voice sound data of the user after receiving the voice gain request by the voice request part 310 from the user. When the voice gain part 330 gains the voice, the data management part 301 causes the voice sound data read part 370 to start to read the voice sound data stored in the voice sound data storage 380, and causes the voice sound data output part 350 to transmit the read voice sound data to the communication part 240. In this system, if the voice is gained, the user data obtained after receiving the voice gain request from the user is transmitted to the PoC server 140 through the network. Here, even after confirming that the voice is gained by the voice gain part 330, the data management part 301 causes the voice sound data storage 380 to store the voice sound data obtained by the voice sound input part 340. When the voice discard part 320 receives the voice discard request from the user, the data management part 301 causes the voice sound data storage 380 to stop storing the voice sound data. After receiving the voice gain request by the voice request part 310 from the user, the data management part 301 reads all the voice sound data obtained in the voice sound input part 340 from the voice sound data storage 380 in the order that the voice sound data is obtained, and transmits the read voice sound data.

If the voice request data is transmitted to the PoC server 140 according to a voice request instruction to the communication part 240 based on an instruction from the user of the portable terminal 100A, the PoC server 140 speech refusal data instead of speech permit data to the portable terminal 100A when the PoC server 140 (see FIG. 1) permits another portable terminal 100B or 100C to speak. When receiving the selection of the data discard mode from the user by operating the reverse mode selection switch 210_3, and after receiving the voice gain request by the voice request part 310 from the user, the data management part 301 discards the untransmitted user data stored in the voice sound data storage 380 if the voice gain part 330 cannot gain the voice within a given time. As a result, the voice sound data which is not transmitted within the given time is deleted and may be updated by the new voice sound data. On the other hand, when the voice gain part 330 cannot gain the voice within the given time even though the user operates the reverse mode selection switch 210_3 to select the data hold mode, the data management part 301 accumulates and holds the untransmitted user data stored in the voice sound data storage 380. When the voice gain part 330 gains the voice later, the data management part 301 causes the communication part 240 to transmit the accumulated and untransmitted user data. In this system, when gaining the voice, the portable terminal 100A of the user can transmit all the voice sound data obtained in past. However, even when the data hold mode is selected, when the user operates the operation part 210 and the forced discard operation is received as the user data reverse request, the voice sound data write part 360 of the data management part 301 discards the untransmitted user data stored in the voice sound data storage 380. In this system, the user can discard the user data at an arbitrary timing desired by the user. The voice sound data write part 360 corresponds to an example of a reset part of the present embodiment of the present invention.

The voice sound data, which is read and is transmitted by the data management part 301, is not immediately discarded, but is directly stored as a database of the transmitted data in the voice sound data storage 380.

The voice sound data receiver 311 illustrated in FIG. 3 stores the voice sound data in the voice sound data storage 380. The voice sound data is received by the communication part 240 from other portable terminals 100B and 100C through the network. The communication part 240 also receives attribute information which accompanies the voice sound data. The attribute information expresses the permit order of the voice of the voice sound data. This attribute information also includes the PoC number identifying a series of speeches, the transmission time, and information on a speaker. The information on a speaker expresses the portable terminal transmitting the voice sound data with the obtained voice in the portable terminals 100A, 100B, and 100C.

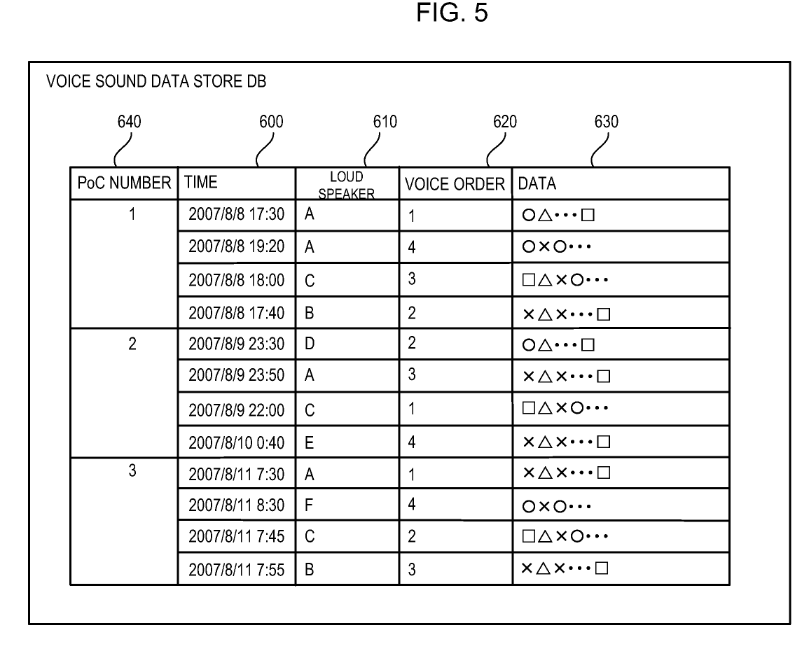

FIG. 5 is a diagram illustrating an example of a structure of a database stored in the voice sound data storage 380.

The voice sound data receiver 311 relates each voice sound data 630 to a PoC number 640, a transmission time 600, a loud speaker 610, and a voice order 620, which is the permit order of the voice, and causes the voice sound data storage 380 to store each voice sound data 630. The voice sound data receiver 311 relates the voice sound data to the attribute information to store the voice sound data and the attribute information in the voice sound data storage 380, so that the history of the voice sound data can be displayed.

Even when the portable terminal 100A itself transmits the voice sound data, the communication part 240 receives the attribute information from the PoC server 140. The attribute information accompanies the obtained speech permit data and expresses the permit order of the voice. The attribute information corresponds to the untransmitted voice sound data stored in the voice sound data storage 380. The attribute information is stored by the data management part 301 in the voice sound data storage 380 as being related to the above untransmitted voice sound data. In the databases illustrated in FIG. 5, an item of the loud speaker 610 that is “A” is the voice sound data transmitted by the portable terminal 100A itself.

The list display part 312 reads the database stored in the voice sound data storage 380, and displays a list of the voice sound data on the liquid crystal display part 220. In this case, the list display part 312 displays the list of the voice sound data in order of the permit order of the voice expressed by the attribute information.

Next, an operation of the portable terminal 100 of the communication network system 10 will be described referring to FIG. 1, FIG. 2, and FIG. 3. Here, the description will be executed on such a condition that the PoC server 140 already maintains and manages a list of a group made up of a plurality of the portable terminals 100, as well as profile information on a user using a portable terminal 100, and the like. Here, the control part 300 of the portable terminal 100 will be described. For example, the operations of the communication part 240, and the like, which are the conditions for the above transmission and receiving, may be omitted because the operations are described above.

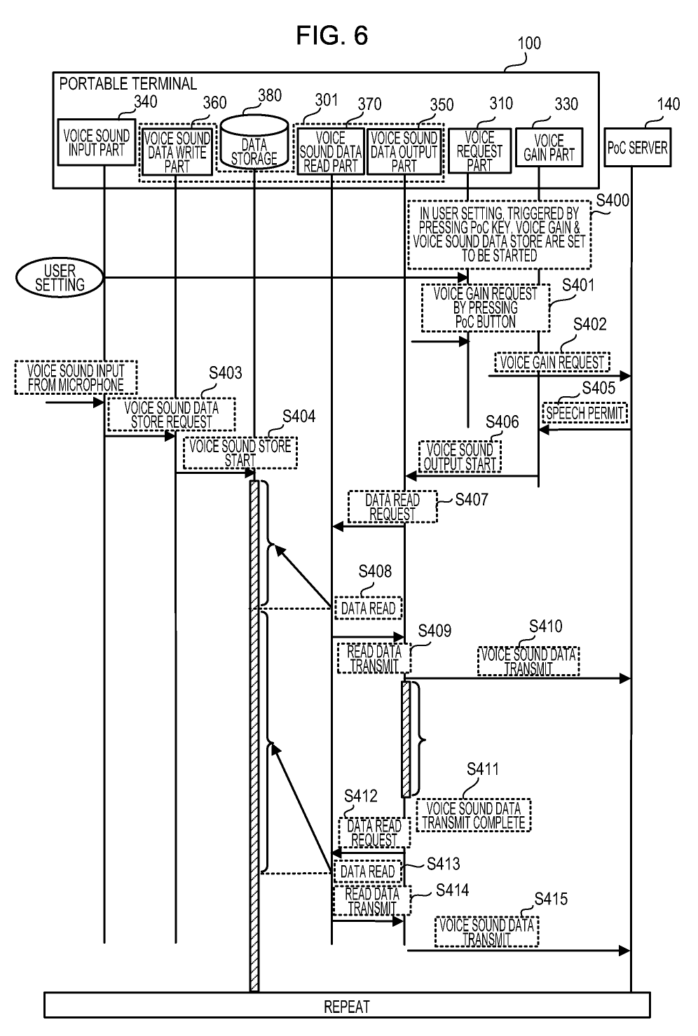

FIG. 6 is a flow illustrating an example of a data transmission operation in the button mode of the portable terminal 100.

The user first executes the user setting with a variety of operations for the portable terminal 100 (Operation S400). For example, the voice selection switch 210_2 receives the voice request selection operation. The button mode requesting the voice is selected by the PoC button 210_1. The discard mode selection switch 210_3 selects the data discard as the discard mode.

When the button mode is selected, and when the user tries to speak by pressing the PoC button 210_1 of the portable terminal 100, the voice request part 310 receives the fact that the PoC button 210_1 of the portable terminal 100 is pressed as the voice gain request by the user (Operation S401). The voice request part 310 instructs the communication part 240 to transmit the voice request data (Operation S402). As a result, the voice request data is transmitted to the PoC server 140. In this case, the voice request part 310 starts measuring a given speech wait time. The given speech wait time can be arbitrarily set by the user operation, and may be, for example, 15 seconds.

Before the speech permit is transmitted from the PoC server 140 to the voice gain part 330, the voice sound input part 340 obtains the voice sound data from the microphone 260. The voice sound input part 340 also transmits a voice sound data store request signal to the voice sound data write part 360 (Operation S403). The voice sound data write part 360 starts writing the voice sound data. Thus, the voice sound, which is spoken by the user to the microphone 260 at nearly the same time when operating the PoC button 210_1, is obtained by the voice sound input part 340, and is stored by the data management part 301 in the voice sound data storage 380.

On the other hand, the voice gain part 330 receives the speech permit from the PoC server 140 within the speech wait time measured by the voice request part 310 (Operation S405). The voice gain part 330 transmits a voice sound output start signal to the voice sound data output part 350 (Operation S406). The voice sound data output part 350 receives the voice sound output start signal transmitted from the voice gain part 330. The voice sound data output part 350 transmits a data read request signal to the voice sound data read part 370 (Operation S407). The voice sound data read part 370 receives the data read request signal transmitted from the voice sound data output part 350. The voice sound data read part 370 reads data from the voice sound data storage 380 (Operation S408). When reading of the data from the voice sound data storage 380 is completed, the voice sound data read part 370 transmits the read data to the voice sound data output part 350 (Operation S409). When receiving of the data from the voice sound data read part 370 is completed, the voice sound data output part 350 transmits the voice sound data to the PoC server 140 through the communication part 240 (Operation S410). While the voice sound data read part 370 is reading the data, the voice sound data write part 360 continues to store the data in the voice sound data storage 380. On the other hand, the data is continuously and repeatedly read from the voice sound data storage 380 (Operations S413, S414, and S415). Thus, the data management part 301 causes the voice sound data storage 380 to store the voice sound data after receiving the voice gain request by the voice request part 310 from the user. After receiving the recognition of the voice gain by the voice gain part 330, the data management part 301 causes the voice sound data read part 370 to read the voice sound data stored in the voice sound data storage 380. Then, the data management part 301 causes communication part 240 to transmit the read voice sound data in the order that the voice sound data is obtained.

If the voice gain part 330 does not receive the speech permit data from the PoC server 140 within the speech wait time measured by the voice request part 310, the data management part 301 discards the untransmitted voice sound data stored in the voice sound data storage 380. This case will be described below.

As described in the operation flow of FIG. 6, in the portable terminal 100, the operation of the voice request by the user and the input timing of the voice sound to be transmitted nearly correspond to each other.

Since the PoC/W phone call is the concurrent same information phone call, it is desirable to gain the voice. If the voice is not gained, a phone call participant cannot transmit the PoC information (for example, voice sound, still image, moving image) to other phone call participants. The user needs to operate (press the PoC button) to gain the voice. Conventionally, this operation merely requests that the voice is gained, but that does not mean that is the operation has started to receive a voice sound like a transceiver, so that it is highly possible the user may misunderstand the operation. As a result, there exists such a disadvantage that it is not possible to transmit data as desired by the user at a timing desired by the user.

According to the above portable terminal 100 of the present embodiment of the present invention, a phone call may be executed without the voice sound being transmitted during the speech after the voice is gained.

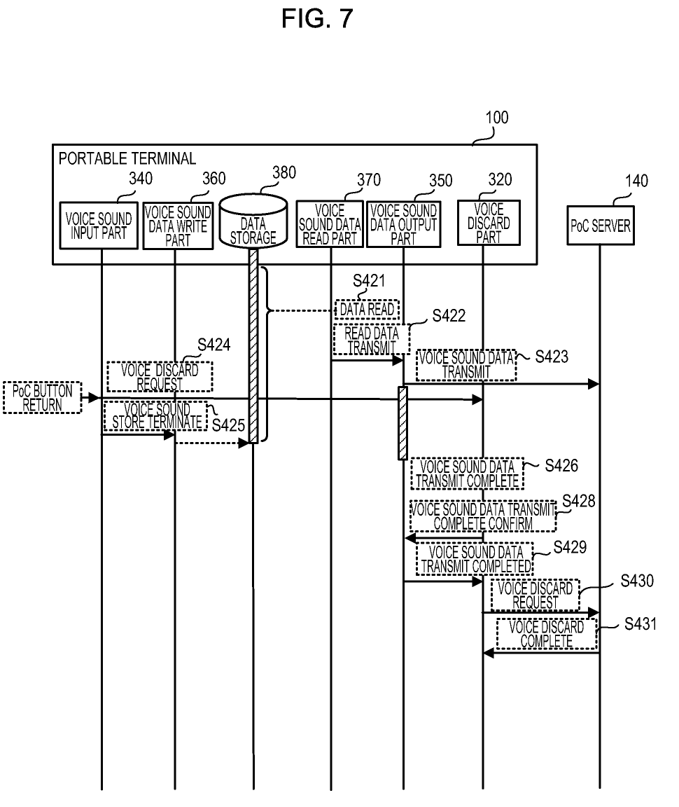

FIG. 7 is an operation flow illustrating the voice discard operation following FIG. 6.

When the button mode is selected by the user, and when the user tries to terminate speaking by pressing the PoC button 210_1 of the portable terminal 100 again to release the PoC button 210_1 to an original condition before pressing the button, the voice discard part 320 receives the fact that the PoC button 210_1 of the portable terminal 100 has been released to the original condition as a voice discard request by the user (Operation S424). The voice sound data write part 360 of the data management part 301 stops writing the user data in the voice sound data storage 380 when the voice discard part 320 receives the voice discard request from the user (Operation S425). Since the stored voice sound data remains in the voice sound data storage 380, the data management part 301 continues to read the voice sound data and to transmit the read voice sound data to the PoC server 140 until the data management part 301 finishes reading all the stored voice sound data (Operations S421, S422, and S423).

When transmission of the voice sound data is completed (Operation S426), the voice discard part 320 transmits a voice sound data transmit complete confirm signal to the voice sound data output part 350 (Operation S428). The voice sound data output part 350 receives the voice sound data transmit complete confirm signal from the voice discard part 320 to confirm that the voice discard part 320 has completed outputting the voice sound. When the voice sound data output part 350 has completed outputting the voice sound, the voice sound data output part 350 transmits a voice sound data transmit completed signal to the voice discard part 320 (Operation S429). If the voice sound data output part 350 has not completed outputting the voice sound, the voice sound data output part 350 waits until it has completed transmitting all the voice sound data, and then transmits a voice sound data transmit completed signal to the voice discard part 320. The voice discard part 320 receives the voice sound data transmit completed signal from the voice sound data output part 350, and transmits the voice discard request to the PoC server 140 (Operation S430). After the voice discard part 320 has completed transmitting the voice sound data before the voice discard request is received, the data management part 301 causes the voice discard part 320 to instruct the communication part 240 to transmit the voice discard data to the PoC server 140. When the voice discard part 320 receives a voice discard complete signal from the PoC server 140 (Operation S431), the PoC communication network system operations are completed.

As described above, in the button mode, all the voice sounds that are inputted after the user presses the PoC button are concurrently transmitted. The voice sound that is inputted after the voice is gained is also continuously transmitted. When the PoC button is released, the voice sound that has been inputted is transmitted. Thus, the user may perform operations that are convenient and easy to use like to the operations of a conventional transceiver to which the user is accustomed.

Next, the data transmission operation in the voice sound mode will be described. In the voice sound mode, parts that are different from the parts of the button mode will be described, and where the same symbol is attached to the same part, the description will be omitted.

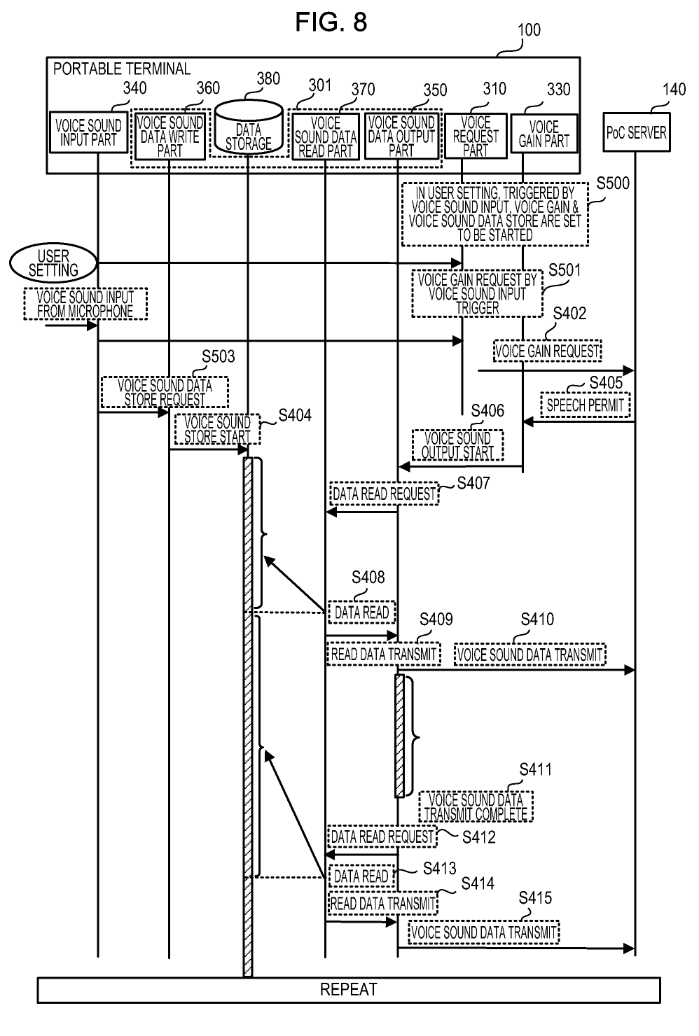

FIG. 8 is an operation flow illustrating the data transmission operation in the voice sound mode of the portable terminal 100.

In the portable terminal 100, the user setting is first executed by a variety of operations by the user (Operation S500). Here, the voice selection switch 210_2 receives the voice request selection operation by the user, and the voice sound mode, which requests the voice with the voice sound input into the microphone 260, is selected. The discard mode selection switch 210_3 selects the data discard as the discard mode.

When the voice sound mode is selected, and when the user speaks to the microphone 260 of the portable terminal 100, the spoken voice sound is inputted into the microphone 260. The voice request part 310 receives the fact that the voice sound data is inputted to the voice sound input part 340 as the voice gain request by the user (Operation S501). The voice request part 310 instructs the communication part 240 to transmit the voice request data (Operation S402). The voice sound input part 340 obtains the voice sound data from the microphone 260, and transmits the voice sound data store request signal to the voice sound data write part 360 (Operation S503). The voice sound data write part 360 starts writing the voice sound data. Thus, the voice sound, which is spoken by the user to the microphone 260 at nearly the same time when the user operates the PoC button 210_1, is obtained by the voice sound input part 340. The voice sound is stored by data management part 301 in the voice sound data storage 380. The following operations are the same as operations of the button mode case described in FIG. 6.

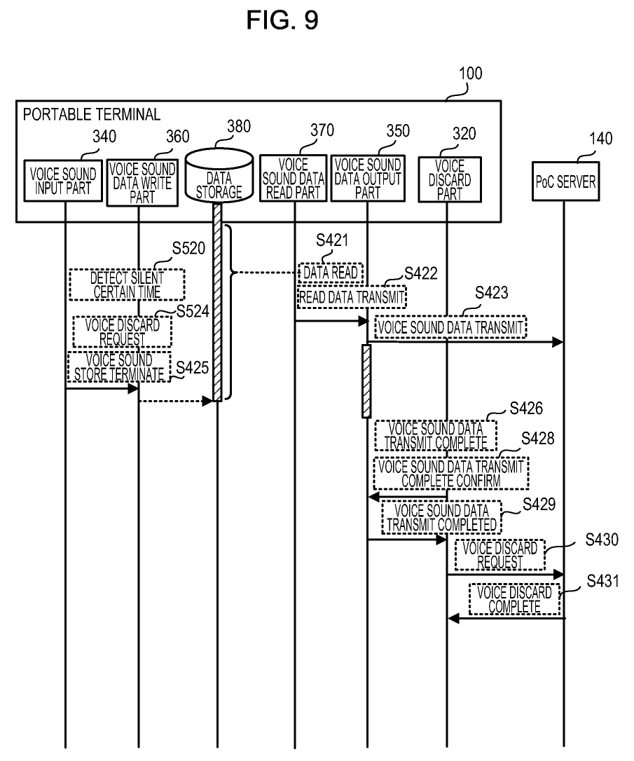

FIG. 9 is an operation flow illustrating the voice discard operation following FIG. 8.

When the user stops speaking and becomes silent, the voice sound inputted into the microphone 260 pauses and becomes silent, and the voice sound input part 340 detects the silence of a certain time length (Operation S520). When the voice sound mode is selected, the voice discard part 320 receives the fact that the voice sound input part 340 detects the silent condition as a voice discard request by the user (Operation S524). The voice sound data write part 360 of the data management part 301 causes the voice sound data storage 380 to stop storing the user data when the voice sound input part 340 detects the silent condition. The voice discard part 320 receives such a silent condition as the voice discard request (Operation S425). The following operations are the same as operations of the button mode described in FIG. 7.

As described above, in the voice sound mode, when the user speaks to the microphone 260 even if the PoC button 210_1 is not pressed, the voice is gained, and the voice sound is concurrently transmitted. When the user stops speaking to the microphone 260, the voice is discarded. Thus, the user may perform operations that are convenient and natural like a mobile telephone to which the user is accustomed.

Up to here, the operations have been described in the case in which the voice gain part 330 receives the speech permit data from the PoC server 140 within a given speech wait time measured by the voice request part 310. Next, the operations will be described in the case that the voice gain part 330 does not receive the speech permit data from the PoC server 140 within the given speech wait time. The following operation, which is different from the above part, will be described, and where the same symbol is attached to the same part, the description will be omitted.

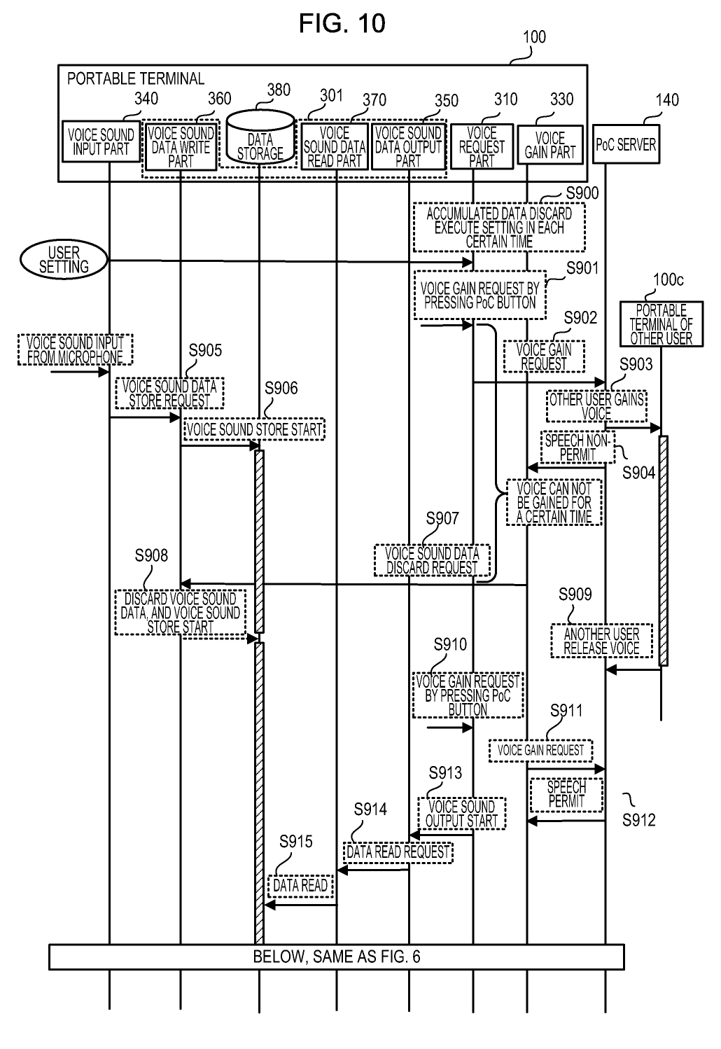

FIG. 10 is an operation flow illustrating an operation of the portable terminal 100 when the speech permit data is not received in the data discard mode.

In the portable terminal 100, the user setting is first executed by a variety of operations by the user (Operation S900). Here, the voice selection switch 210_2 receives the voice request selection operation by the user, and the voice sound mode is selected which requests the voice with the voice sound input by the user into the microphone 260. When the user presses the discard mode selection switch 210_3, the data discard is selected as the discard mode.

When the button mode is selected, and when the user tries to speak by pressing the PoC button 210_1 of the portable terminal 100, the voice request part 310 receives the fact that the PoC button 210_1 of the portable terminal 100 is pressed as the voice gain request by the user (Operation S901). The voice request part 310 instructs the communication part 240 to transmit the voice request data (Operation S902). Thus, the voice request data is transmitted to the PoC server 140. The voice request part 310 starts measuring the given speech wait time. The given speech wait time can be arbitrarily set by the operation by the user, and may be, for example, 15 seconds.

Before the speech permit data is transmitted from the PoC server 140 to the voice gain part 330, the voice sound input part 340 obtains the voice sound data from the microphone 260. The voice sound input part 340 also transmits a voice sound data store request signal to the voice sound data write part 360 (Operation S905). The voice sound data write part 360 starts writing the voice sound data (Operation S906).

Here, when the portable terminal 100C of another user gains the voice (Operation S903), the PoC server 140 transmits the speech refusal data but does not transmit the speech permit data. When the voice gain part 330 cannot gain the voice within the given speech wait time, the voice gain part 330 transmits the voice sound data discard request to the voice sound data write part 360 of the data management part 301 (Operation S907). The voice sound data write part 360 discards the untransmitted user data stored in the voice sound data storage 380 (Operation S908). As described above, when the voice gain part 330 does not gain the voice within the given speech wait time after receiving the voice gain request by the voice request part 310 from the user, the data management part 301 discards the untransmitted voice sound data stored in the voice sound data storage 380. However, after that, the voice sound data obtained by the voice sound input part 340 also continues to be stored by the data management part 301 in the voice sound data storage 380. That is, the voice sound data is updated by the newest data. When it is not necessary to store the voice sound data, the transmitted voice sound data may be deleted from the voice sound data storage 380.

Next, when the user tries to speak again by pressing the PoC button 210_1 of the portable terminal 100, the voice request part 310 receives the fact that the PoC button 210_1 of the portable terminal 100 is pressed as the voice gain request by the user (Operation S910). Next, the voice request part 310 instructs the communication part 240 to transmit the voice request data (Operation S911). In addition, the voice request part 310 starts measuring the voice wait time again. In this way, the voice request data is transmitted to the PoC server 140.

Meanwhile, the portable terminal 100C of the other user releases the voice (Operation S909), the voice gain part 330 receives the speech permit data from the PoC server 140 within the given speech wait time (Operation S912). The voice gain part 330 transmits a voice sound output start signal to the voice sound data output part 350 (Operation S913). The voice sound data output part 350 receives the voice sound output start signal transmitted from the voice gain part 330. The voice sound data output part 350 transmits a data read request signal to the voice sound data read part 370 (Operation S914). The voice sound data read part 370 receives the data read request signal transmitted from the voice sound data output part 350, and reads the voice sound in order from the voice sound data storage 380 (Operation S915). The following operations are the same as the operations described in FIG. 6.

As described above, the new voice sound is concurrently transmitted. Next, the operations that are executed when the data hold is selected as the discard mode, and when the voice gain part 330 does not receive the speech permit data from the PoC server 140 within the given speech wait time will be described. Since the operations when the data hold is selected are the same as those of FIG. 10, the description will be omitted, and the parts that are different from the data discard will be described.

When the user selects the data hold, in the user setting (Operation S900), the discard mode selection switch 210_3 selects the data hold as the discard mode.

When the data hold is selected by the user, the voice gain part 330 does not transmit a voice sound discard request even when the voice is not gained within the given speech wait time. Thus, the voice sound data write part 360 holds the untransmitted user data stored in the voice sound data storage 380.

As a result, when the voice gain part 330 gains the voice later (Operation S912), and when the data management part 301 causes the communication part 240 to transmit the untransmitted user data, all the untransmitted user data is concurrently transmitted in the order that the untransmitted user data is stored.

Next, an operation that is executed when the portable terminal 100 is moved outside the communication range and data cannot be transmitted and received to and from the network that includes the base station 120 (refer to FIG. 1).

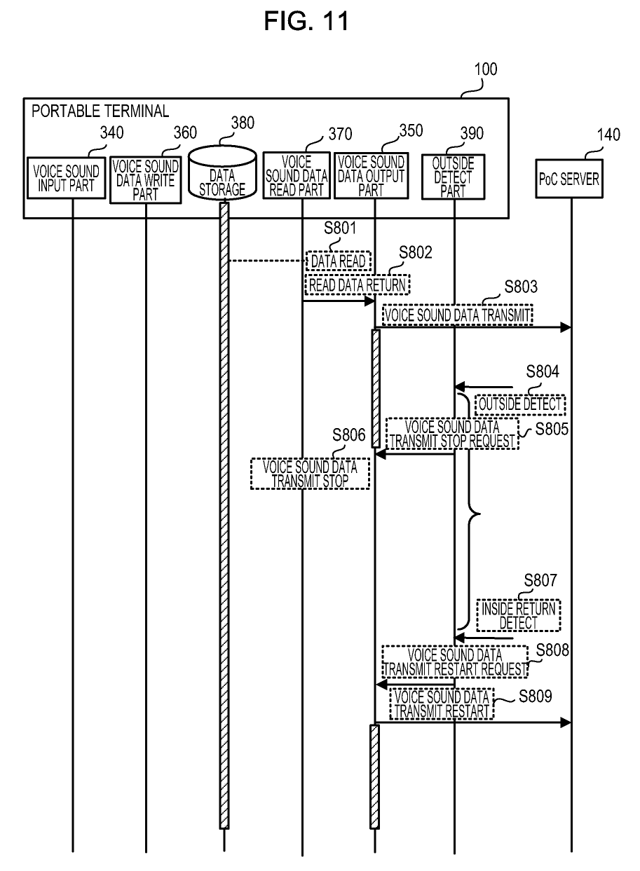

FIG. 11 is an operation flow illustrating an operation when the portable terminal 100 is temporarily moved outside the communication range.

While the voice sound data stored in the voice sound data storage 380 is being read and transmitted (Operations S801, S802, and S803), when the portable terminal 100 is outside the communication range and data cannot be transmitted and received because the portable terminal 100 has been moved accompanying the movement of the user or because the electric wave environment is degraded, the outside detect part 390 detects the changed condition from inside the communication range to outside the communication range (Operation S804), and requests the voice sound data output part 350 of the data management part 301 to stop transmitting the voice sound data (Operation S805). As a result, the voice sound data read part 370 of the data management part 301 stops reading and transmitting the voice sound data (Operation S806).

After that, when the portable terminal 100 moves back inside a communication range in which data can be transmitted and received, the outside detect part 390 detects the changed condition from outside the communication range to inside the communication range (Operation S807). The outside detect part 390 requests the voice sound data output part 350 of the data management part 301 to restart transmitting the voice sound data (Operation S808). As a result, the voice sound data read part 370 and the voice sound data output part 350 of the data management part 301 restart reading and transmitting the voice sound data (Operation S806). Thus, even when the portable terminal 100 is moved outside of the communication range, the voice sound data is not lost, and after releasing inside the communication range, all the voice sound data is transmitted by the voice sound data read part 370. Thus, when the voice sound of the user speaking with the voice obtained is discontinued outside of the communication range, it is not necessary to speak once again after releasing to inside the communication range.

While the above embodiments described the portable terminal as a communication terminal, aspects of the embodiments of the present invention are not limited to this example, and may be applied to a communication network system in which the concurrent transmission may be executed.

In addition, while the above embodiments described the voice sound data as the user data, aspects of the embodiments of the present invention are not limited to this example, and may be applied to, for example, image data.

What is claimed is:

1. A communication terminal connectable to a communication network system, comprising:
a communication network system which transmits, to other communication terminals via a network, user data obtained from one communication terminal that has gained a voice within a communication group made up of a plurality of communication terminals;
a transmitter which transmits data to the network;
a receiver which receives data transmitted through the network;
a voice request part which receives a voice gain request from a user to instruct the transmitter to transmit the voice request data;
a voice gain recognition part which recognizes that the voice is gained when the receiver receives speech permit data;
a data obtaining part which obtains the user data;
a data storage which stores data; and
a data management part which causes the data storage to store the user data obtained by the data obtaining part after receiving a voice gain request by the voice request part from the user, receives recognition that the voice is gained by the voice gain recognition part, and causes the transmitter to transmit the user data obtained by the data obtaining part after receiving the voice gain request transmitted by the voice request part from the user.

2. The communication terminal according to claim 1, wherein
the data management part causes the data storage to store the user data after the voice gain recognition part recognizes that the voice is gained, and
the data management part causes the transmitter to read the user data from the data storage in the order that the user data is obtained and to transmit the user data, the user data being obtained by the data obtaining part after receiving the voice gain request by the voice request part from the user.

3. The communication terminal according to claim 1, wherein
the voice request part receives the voice gain request from the user to instruct the transmitter to transmit the voice request data, and receives a voice discard request from the user to instruct the transmitter to transmit voice discard data, and
the data management part causes the data storage to stop storing the user data when the voice request part receives the voice discard request from the user, and causes the voice request part to instruct the transmitter to transmit the voice discard data after it has completed transmitting the user data before receiving the voice discard request from the transmitter.

4. The communication terminal according to claim 2, wherein
the voice request part receives the voice gain request from the user to instruct the transmitter to transmit the voice request data, and receives a voice discard request from the user to instruct the transmitter to transmit voice discard data, and
the data management part causes the data storage to stop storing the user data when the voice request part receives the voice discard request from the user, and causes the voice request part to instruct the transmitter to transmit the voice discard data after it has completed transmitting the user data before receiving the voice discard request from the transmitter.

5. The communication terminal according to claim 3, wherein
the data management part discards untransmitted user data stored in the data storage when a given time is exceeded from a time point when receiving the voice gain request by the voice request part from the user.

6. The communication terminal according to claim 3, wherein
the data management part further includes
a reset part which receives a user data discard request from the user to discard the untransmitted user data stored in the data storage.

7. The communication terminal according to claim 1, further comprising:
a discard mode selection part which receives a discard mode selection operation by the user, the discard mode selection operation selecting any one of a data discard mode and a data hold mode,
wherein,
when the discard mode selection part receives an operation selecting the data discard mode, and when the voice gain recognition part does not gain the voice within a given time after receiving the voice gain request by the voice request part from the user, the data management part discards the untransmitted user data stored in the data storage,
when the discard mode selection part receives an operation selecting the data hold mode, and when the voice gain recognition part does not gain the voice within the given time after receiving the voice gain request by the voice request part from the user, the data management part holds the untransmitted user data stored in the data storage, and
when the voice gain recognition part gains the voice later, the data management part causes the transmitter to transmit the stored untransmitted user data.

8. The communication terminal according to claim 2, further comprising:
a discard mode selection part which receives a discard mode selection operation by the user, the discard mode selection operation selecting any one of a data discard mode and the data hold mode,
wherein,
when the discard mode selection part receives an operation selecting the data discard mode, and when the voice gain recognition part does not gain the voice within a given time after receiving the voice gain request by the voice request part from the user, the data management part discards the untransmitted user data stored in the data storage,
when the reverse mode selection part receives an operation selecting the data hold mode, and when the voice gain recognition part does not gain the voice within a given time after receiving the voice gain request by the voice request part from the user, the data management part holds the untransmitted user data stored in the data storage, and
when the voice gain recognition part gains the voice later, the data management part causes the transmitter to transmit the stored untransmitted user data.

9. The communication terminal according to claim 1, wherein
the data obtaining part obtains a voice sound as the user data, and
the voice request part receives the fact that the voice sound is obtained by the data obtaining part as the voice gain request by the user.

10. The communication terminal according to claim 3, wherein
the data obtaining part obtains the voice sound as the user data, and
the voice request part receives the fact that the voice sound is obtained by the data obtaining part as the voice gain request by the user.

11. The communication terminal according to claim 1, further comprising:
a voice request selection part which receives a voice request selection operation by the user,
wherein
according to the voice request selection operation received by the voice request selection part, the voice request part selects a type of an input to be received as the voice gain request by the user.

12. The communication terminal according to claim 2, further comprising:
the voice request selection part which receives the voice request selection operation by the user,
wherein
according to the voice request selection operation received by the voice request selection part, the voice request part selects a type of an input to be received as the voice gain request by the user.

13. The communication terminal according to claim 3, wherein
the data obtaining part obtains the voice sound as the user data, and
the voice request part receives the fact that a silent condition is detected by the data obtaining part as the voice discard request by the user.

14. The communication terminal according to claim 1, wherein
the receiver receives attribute information accompanying the speech permit data, and expressing a permit order of the voice, and
the data management part causes the data storage to store the user data and the attribute information corresponding to the user data.

15. The communication terminal according to claim 1, wherein
the receiver receives the user data and the attribute information expressing the permit order of the voice from the communication terminal which is different from the present communication terminal through the network, and
the data management part causes the data storage to store the user data and the attribute information received by the receiver.

16. The communication terminal according to claim 15, further comprising:
a list display part which arranges a list of the user data stored in the data storage in the permit order expressed by the attribute information related to the corresponding user data, and displays the list.

17. The communication terminal according to claim 1, wherein
the data management part reads the user data from the data storage, and causes the transmitter not to transmit a given invalid part of the read user data, but to continue transmitting the other parts.

18. The communication terminal according to claim 1, further comprising:
a detection part which detects a changed condition between a condition inside a communication range in which the communication terminal can transmit and receive data to and from the network, and a condition outside the communication range,
wherein,
when the detection part detects a change from the condition inside the communication range to the condition outside the communication range, the data management part stops transmitting the user data, and when the detection part detects a change from the condition outside the communication range to the condition inside the communication range, the data management part restarts transmitting the user data.

19. A communication method that causes a computer to function as a communication terminal connectable to a communication network system, the communication terminal transmits, to other communication terminals through a network, user data obtained by one communication terminal which gains a voice, the communication method comprising the processes of:
a transmitting process transmitting data to the network;
a receiving process receiving data transmitted through the network;
a voice requesting process, which receives a voice gain request from a user, instructing the transmitting process to transmit voice request data;
a voice gain recognizing process recognizing that a voice is gained when the receiving process receives speech permit data;
a data obtaining process obtaining user data;
a data storing process storing data; and
a data management process causing the data storing process to store the user data obtained in the data obtaining process after receiving a voice gain request from the user in the voice requesting process, receiving a recognition result that the voice is gained in the voice gain recognizing process, and causing the transmitting process to transmit the user data obtained in the data obtaining process after receiving the voice gain request transmitted by the voice requesting process from the user.

20. A computer-readable recording medium storing a computer program for causing a computer to function as a communication terminal connectable to a communication network system, the communication terminal transmitting user data obtained by one communication terminal which gains a voice to the other communication terminals through a network,
the computer program comprising the steps of:
a transmitting step transmitting data to the network;
a receiving step receiving data transmitted through the network;
a voice requesting process, which receives a voice gain request from a user, instructing the transmitting process to transmit voice request data;
a voice gain recognizing step recognizing that a voice is gained when the receiving step receives speech permit data;
a data obtaining step obtaining user data;
a data storing step storing data; and
a data management step causing the data storing step to store the user data obtained in the data obtaining step after receiving a voice gain request transmitted in the voice requesting step from the user, receiving a recognition result of the voice gain in the voice gain recognizing step, and causing the transmitting step to transmit the user data obtained in the data obtaining step after receiving the voice gain request by the voice requesting step from the user.
